(19) United States
(12) Patent Application Publication
(10) Pub. No.: US 2014/0356278 A1
(43) Pub. Date: Dec. 4, 2014

(54) Manufacturing Method of Hydrothermal Generation of Hydrogen and Apparatus Thereof

(71) Applicant: NATIONAL CHENG KUNG UNIVERSITY, Tainan City (TW)

(72) Inventors: Dong-hwang CHEN, Tainan City (TW); Yu-ching TSAI, Tainan City (TW); Jan-antoni ROGUT, Gliwice City (PL)

(21) Appl. No.: 13/906,005

(22) Filed: May 30, 2013

(51) Int. Cl. C01B 3/08

(52) U.S. Cl. CPC C01B 3/08; B01J 2219/00051
USPC 423/658; 422/162

(57) ABSTRACT

A manufacturing method of hydrothermal generation of hydrogen is provided and includes steps of: providing an iron powder having a particle diameter from 100 nm to 10 mm; providing water of liquid status; mixing the iron powder and the water to form a mixture; and heating the mixture to the temperature between 100° C. and 200° C. to generate hydrogen. The hydrogen generated by the present invention could be used directly due to its high purity. The carbon dioxide would not be produced during the manufacturing process. The advantages of the present invention are that the manufacturing process will not cause environmental pollution and it is easy to carry out mass production.

### FIELD OF THE INVENTION

The present invention relates to the manufacturing method and apparatus of hydrothermal generation of hydrogen, particularly relates to a reaction carried out by nano- and/or micron-scale iron powder with water of liquid status to generate hydrogen gas.

### BACKGROUND OF THE INVENTION

In recent years, due to soaring inflation of oil prices, the shortage of current oil energy is indirectly reflected. Moreover, oil combustion always accompanies carbon dioxide emissions which pollute our living environment and cause the greenhouse effect. In the increasing of environmental consciousness, a variety of energy which can replace conventional oil is actively developed, in which hydrogen energy is the focal point of urgent development.

Current commercialized methods of hydrogen production are mainly divided into two sorts according to the original material. One kind of the methods based on fossil fuels to produce hydrogen includes: steam reforming, partial oxidation and coal gasification. These methods require carbonaceous fossil as the raw materials, and therefore the production process of the hydrogen is inevitably accompanied by the exhaust gas emissions of carbon dioxide which will cause environmental problems in the mass production. Another kind of hydrogen production methods uses non-fossil fuels as the raw material, the more common method is water splitting by electrolysis. Water splitting by electrolysis is a traditional and mature hydrogen production method, its manufacturing equipment requires only two electrodes (cathode and anode) placed in the electrolyte. While the direct current passing through the two electrodes, the water of the electrolyte will be electrolyzed into hydrogen and oxygen. Although the process of water splitting by electrolysis is simple and non-polluting, electricity costs are generally about 75 to 80% of the total production cost because of the high power consumption. It has less economic advantages compared to the hydrogen production methods from fossil fuels in mass production. Therefore, hydrogen yield of water splitting by electrolysis is less than 5% of the global hydrogen production, In addition, there are some hydrogen production methods which use water as raw material, due to the lower energy level of the water, it is necessary to apply a very high temperature to obtain hydrogen and therefore very energy-consuming. In these methods, water is directly heated to more than 3000° C. so that the water becomes to water vapor, the steam directly decomposed into hydrogen and oxygen. However, its operating temperature is too high, and thus the heat supply is a major problem.

It is therefore tried by the inventor to develop a manufacturing method of hydrothermal generation of hydrogen to solve the problems existing in the conventional technology, with the advantages of a simple production process, low cost and non-polluting, and can produce a high purity hydrogen gas to facilitate use, as described above.

### SUMMARY OF THE INVENTION

A primary object of the present invention is to provide a manufacturing method of hydrothermal generation of hydrogen, which is heating the water of liquid status to a certain temperature, so that the oxidation and reduction of water and iron powder will be proceeded to produce hydrogen which can be used directly and not be further purified.

A secondary object of the present invention is to provide a manufacturing method of hydrothermal generation of hydrogen, which utilizes the nano- and/or micro-scale iron powder and water of liquid status to increase the contact area between the iron powder and water to accelerate the reaction rate, thereby increasing the efficiency of hydrogen preparation.

A further object of the present invention is to provide a hydrogen production method of a low cost, easy process and easy to mass-produce hydrogen. Because water of liquid status is easy to obtain and lower cost, it is suitable for use in the mass production process. In addition, iron powder will form the iron oxides after the reaction, and the iron oxides can be naturally separated from the hydrogen and are not subject to complicated treatment. Moreover, the iron oxides are the substance easy to recover to use again because they only need a simple surface treatment to be reduced to iron metal.

To achieve the above object, the present invention provides a manufacturing method of hydrothermal generation of hydrogen which comprises the steps of: providing an iron powder having a particle diameter from 100 nm to 10 mm; providing water of liquid status; mixing the iron powder and the water in a sealed container to form a mixture; and heating the mixture to the temperature between 100 to 200° C., so that the iron powder reacts with the water to generate hydrogen.

In one embodiment of the present invention, the weight percentage of the iron powder is 10% to 30% of the mixture.

In one embodiment of the present invention, the heating temperature is between 120 to 150° C.

In one embodiment of the present invention, before the step of mixing the iron powder and the water, further comprising a surface treatment step to remove impurities or iron oxides on the surface of the iron powder.

In one embodiment of the present invention, the surface treatment step is to immerse and clean the iron powder in a diluted acid.

In one embodiment of the present invention, the volume concentration of the diluted acid is greater than 0.1M.

Furthermore, the present invention provides an apparatus for hydrothermal generation of hydrogen which comprises a reaction container made of pressure-resistant material for accommodating a mixture of an iron powder and water of liquid status; a heating device for heating the mixture in the reaction container to produce a mixed gas of hydrogen and water vapor; a cooling device having a first opening and a second opening, and the first opening being engaged closely with an opening of the reaction container to cool the mixed gas; and a gas collector, which is engaged closely with the second opening of the cooling device; wherein the angle between an extending direction of the cooling device and the plane of ground is equal to or less than 90 degree.

In one embodiment of the present invention, a first valve is disposed at a junction between the first opening of the cooling apparatus and the opening of the reaction container to control whether the water vapor generated by heating the mixture is cooled to be condensed and back to the reaction container.

In one embodiment of the present invention, a second valve is disposed at a junction between the second opening of the cooling device and the gas collector to control whether the hydrogen flow to the gas collector.

### DESCRIPTION OF THE DRAWINGS

FIG. 1 is a side view of the reaction apparatus for hydrothermal generation of hydrogen according to a second embodiment of the present invention;

FIG. 2 is a graph of the weight percentage of the iron powder used in the hydrothermal generation of hydrogen according to the preferred embodiment of the present invention;

FIG. 3 is a yield graph of the hydrogen generated by the iron powder with a micro-scale particle diameter (3 mm) while the reaction temperature is changed according to the preferred embodiment of the present invention; and

FIG. 4 is a yield graph of the hydrogen generated by the iron powder with a nano-scale particle diameter (100 nm) while the reaction temperature is changed according to the preferred embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, and etc., are only directions by referring to the accompanying drawings, and thus the used directional terms are used to describe and understand the present invention, but the present invention is not limited thereto.

The manufacturing method of hydrothermal generation of hydrogen according to the first embodiment of the present invention mainly includes the following steps: providing an iron powder; providing a water of liquid status; mixing the iron powder and the water in a sealed container to form a mixture; and heating the mixture, so that the iron powder reacts with the water to generate hydrogen. Each of the above steps and its principles of the first embodiment will be described in detail below.

First, in the manufacturing method of hydrothermal generation of hydrogen according to the first embodiment of the present invention, an iron powder is provided. In this step, the iron powder may be a powder of nanometer or micrometer size, for example, having a particle diameter of 100 nm to 10 microns. Subsequently, the iron powder, and a water of liquid status are placed in a sealed container to be mixed together to form a mixture. The way of mixing is not limited, the mixture can be uniform by stirring, or put it aside also. The iron powder in the mixture is preferably completely immersed in the water, the weight percentage of the iron powder may be between 5-60%, for example, is 10%, 20%, 30% or 40%. Subsequently, the mixture is heated to 100° C. or more by the heating device, preferably 100° C. to 200° C., for example, 120° C., 150° C. or 180° C. At this time, the iron powder starts to react with the water to produce hydrogen. Preferably, a surface treatment step can be apply to the iron powder before mixing the iron powder and the water in order to remove impurities and the iron oxides on the surface of the iron powder. The iron powder can be soaked with a diluted acid in the surface treatment, and the concentration of the diluted acid is preferably 0.1M. The diluted acid can be, for example, a diluted hydrochloric acid, a diluted nitric acid, a diluted sulfuric acid, a diluted acetic acid, or other kinds of acids.

There are no other gases existing except hydrogen produced by the manufacturing method according to the first embodiment of the present invention which is mixed with the water vapor evaporated by heating the mixture, and therefore it is easy to obtain the hydrogen with high purity and easy for use. The reaction is as follows:

3Fe+4H₂O→Fe₃O₄+4H₂

Furthermore, using the iron powder with nanometer or micrometer particle diameter can increase the total area of the contact surface between the iron powder and the water, so that the reaction rate is increasing and the generation speed of the hydrogen is faster.

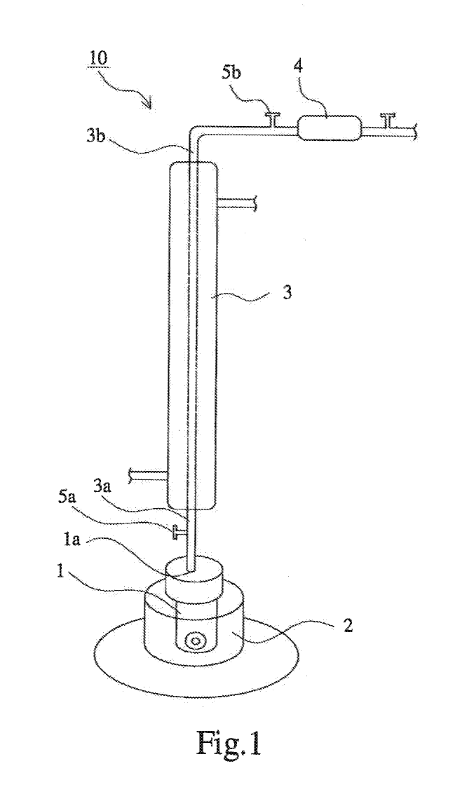

Referring now to FIG. 1, a side view of an apparatus for hydrothermal generation of hydrogen according to a second embodiment of the present invention is illustrated. As shown, the apparatus for the hydrothermal generation of hydrogen designated by numeral 10 can be used for heating and collecting the generated hydrogen. The apparatus comprises a reaction container 1 made of pressure-resistant material for accommodating a mixture of an iron powder and water of liquid status; a heating device 2 for heating the mixture in the reaction container to produce a mixed gas of hydrogen and water vapor; a cooling device 3 having a first opening 3a and a second opening 3b, and the first opening 3a being engaged closely with an opening of the reaction container 1 to cool the mixed gas; and a gas collector 4, which is engaged closely with the second opening 3b of the cooling device 3. The reaction container 1 is preferably made of pressure-resistant material due to the need to withstand the pressure of the water vapor and hydrogen generated by heating the mixture, for example, stainless steel. The reaction container 1 can be selectively connected with a pressure detector (not shown) to know the pressure during the reaction carried out at all times.

Furthermore, the heating device 2 is used for heating of the reaction container 1 uniformly, and it can be optionally connected with a thermal controller (not shown) for precisely controlling the desired reaction temperature at 100° C. to 200° C. The cooling device 3 preferably has an angle between the extending direction of the cooling device and the plane, and the angle is equal to or less than 90 degree, for example, 30 degree, 45 degree, 60 degree or 90 degree. Therefore, gravity can be used for the automatic separation of liquid water when the mixed gases of hydrogen and water vapor are condensed. Subsequently, the hydrogen passes through the second opening 3b and then enters the gas collector 4. The liquid water passes through the first opening portion 3a of the cooling device 3 and falls back to the reaction container 1, and proceeds the reaction with iron powder. The gas collector 4 may also be selectively connected with a pressure detector (not shown) to know the collection status of the generated hydrogen at all times.

In addition, a first valve 5a is optionally installed between the first opening 3a and the opening 1a of the reaction container 1. The first valve 5a is used to control whether the mixed gas (containing water vapor and hydrogen) passes through the cooling device 3, so that the water vapor is condensed back to the reaction container 1 and separated from the hydrogen. A second valve 5b is optionally installed between the second opening 3b and the gas collector 4 to control whether the hydrogen flows to the gas collector 4.

With regard to the efficiency of hydrogen production, the experimental data and charts of the present invention please refer to the following instructions.

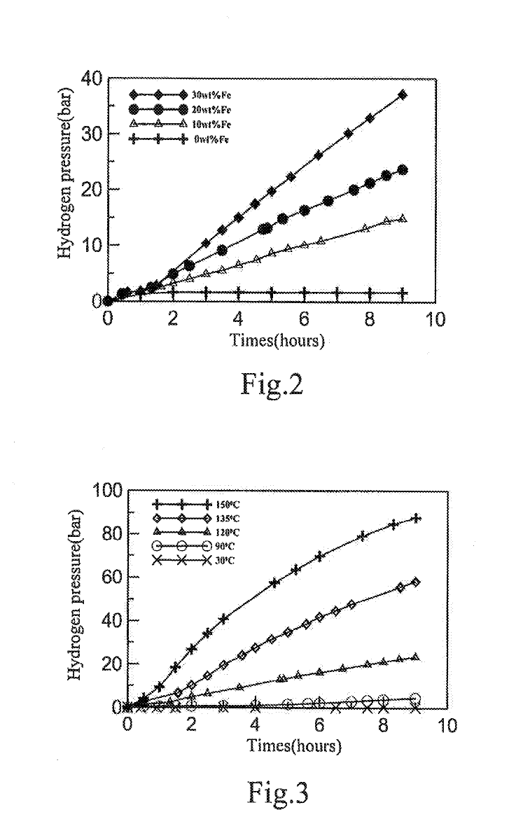

Referring to FIG. 2, which is a graph showing the influence to the hydrogen production caused by changing the weight percentage of the iron powder. By changing the weight percentage of the iron powder with micro-scale particle diameter (3 microns) from 0%, 10%, 20% and 30% of the mixture, it can be observed that the changes in the production amount of hydrogen. As shown in FIG. 2, the hydrogen yield increases with the increasing content of the iron powder, and shows a stable upward trend within nine hours.

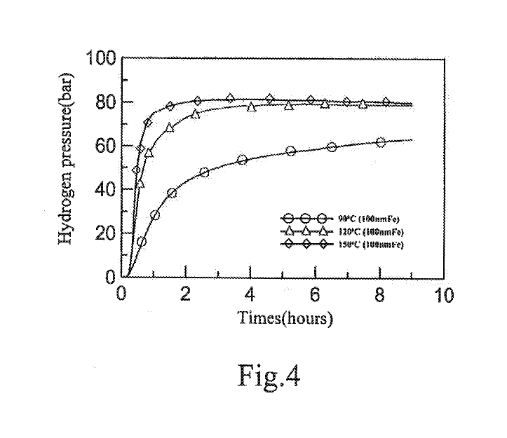

Referring to FIG. 3, which is a graph showing the influence to the hydrogen production caused by changing the reaction temperature. By changing different reaction temperature of 30° C., 90° C., 120° C., 135° C. and 150° C., it can be observed that the changes in the production amount of hydrogen. The iron powder used in this experiment has the particle diameter of 3 micrometers, and the content is 20% by weight of the mixture. As shown in FIG. 3, the efficiency of hydrogen production is not significant when the temperature is below 100° C. , but when the reaction temperature keeps at 150° C. for nine hours, the hydrogen will be generated to the pressure of 88 bar (as shown in FIG. 2). If the particle diameter of the iron powder is changed to nano-scale (100 nm, the weight percentage of 20%), the hydrogen production rate can be more improved significantly with the increasing temperature and the reaction will reach equilibrium within two hours, as shown in FIG. 4. Accordingly, the reaction temperature should be greater than 100° C., the preferred range is between 120° C. to 150° C., for larger hydrogen yield within a controlled time when the iron powder of micron-scale or nano-scale is used.

In addition, comparing FIG. 3 with FIG. 4, it can be observed that the hydrogen production with the iron powder of micron-scale and nano-scale has the maximal difference at 90° C. and 120° C. In view of the reaction rate, the hydrogen production rate with the nano-scale iron powder is much higher than the hydrogen production rate with a micro-scale iron powder because the nano-powder can significantly increase the contact surface and the activity of the reactant. According to the experimental results, after the iron powder in the micro-scale react for 9 hours and 24 hours, the conversion rate were 24.16% and 45.09%, respectively; and when the nano-scale iron powder react at 90° C., 120° C. and 150° C., the conversion rate were 59.13%, 63.38% and 64.42%, respectively.

In summary, the manufacturing method and apparatus of hydrothermal generation of hydrogen of the present invention has the advantages of simple process and easy to mass production. The produced hydrogen thereby can be used directly after collecting due to its high purity, Furthermore, the reactants used for the present invention are the iron powder and liquid water, both of them are the material which is easy to obtain and prepare. The product except for hydrogen contains only the iron oxides after the reaction, and will not cause environmental pollution. The iron oxides on the surface of the iron powder can be removed and cleaned simply by using the diluted acids and then the iron powder is recycled to take advantage of the cost savings and comply with current green trends.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A manufacturing method of hydrothermal generation of hydrogen, comprising steps of:
providing an iron powder having a particle diameter from 100 nm to 10 mm;
providing water of liquid status;
mixing the iron powder and the water in a sealed container to form a mixture; and
heating the mixture to the temperature between 100 to 200 t, so that the iron powder reacts with the water to generate hydrogen.

2. The manufacturing method according to claim 1, wherein the weight percentage of the iron powder is 10% to 30% of the mixture.

3. The manufacturing method according to claim 1, wherein the heating temperature is between 120 to 150° C.

4. The manufacturing method according to claim 1, wherein before the step of mixing the iron powder and the water, further comprising a surface treatment step to remove impurities or iron oxides on the surface of the iron powder.

5. The manufacturing method according to claim 4, wherein the surface treatment step is to immerse and clean the iron powder in a diluted acid.

6. The manufacturing method according to claim 5, wherein the concentration of the diluted acid is greater than 0.1M.

7. An apparatus for hydrothermal generation of hydrogen, comprising:
a reaction container made of pressure-resistant material to accommodate a mixture of an iron powder and water of liquid status;
a heating device to heat the mixture in the reaction container to produce a mixed gas of hydrogen and water vapor;
a cooling device having a first opening and a second opening, and the first opening being engaged closely with an opening of the reaction container to cool the mixed gas; and
a gas collector, which is engaged closely with the second opening of the cooling device;
wherein the angle between an extending direction of the cooling device and the ground is equal to or less than 90 degree.

8. The apparatus according to claim 7, wherein a first valve is disposed at a junction between the first opening of the cooling apparatus and the opening of the reaction container to control whether the water vapor generated by heating the mixture is cooled to be condensed and back to the reaction container.

9. The apparatus according to claim 7, wherein a second valve is disposed at a junction between the second opening of the cooling device and the gas collector to control whether the hydrogen flow to the gas collector.
